(19) United States
(12) Patent Application Publication
(10) Pub. No.: US 2024/0170709 A1
(43) Pub. Date: May 23, 2024

(54) MOTION SYNCHRONIZED MULTI-TIER PALLET RACK AND BATTERY FORMATION APPARATUS HAVING THE SAME

(71) Applicant: CHROMA ATE INC., Taoyuan City (TW)

(72) Inventors: Ming-Cheng Huang, Taoyuan City (TW); Jiun-Ren Chen, Taoyuan City (TW); Chao-Cheng Wu, Taoyuan City (TW); Yi-Sheng Hsu, Taoyuan City (TW)

(73) Assignee: CHROMA ATE INC., Taoyuan City (TW)

(21) Appl. No.: 18/373,726

(22) Filed: Sep. 27, 2023

(30) Foreign Application Priority Data
Nov. 21, 2022 (TW) 111212732

(51) Int. Cl. H01M 10/04; B65G 1/02

(52) U.S. Cl. CPC H01M 10/0404; B65G 1/026; H01M 10/0481; B65G 2201/0267

(57) ABSTRACT

A motion synchronized multi-tier pallet rack and a battery formation apparatus are provided. The pallet rack includes a fixation rack, two movable frames, and two actuators. The movable frames are coupled to two corresponding sides of the fixation rack and each includes telescopic arms, a motor, and a drive rod. The actuators are disposed on other the two corresponding sides of the fixation rack to drive the movable frames to move toward or away from each other. The telescopic arms are kinematically connected to the motor through the drive rod to extend from or retract into the movable frame. The battery formation apparatus includes a motion synchronized multi-tier pallet rack, a conveyor module, a formation cabinet, and a controller. The conveyor module carries a battery module. The controller controls the pallet rack to obtain the battery module from the conveyor module and place the battery module in the formation cabinet.

### CROSS-REFERENCE TO RELATED APPLICATION

This non-provisional application claims priority under 35 U.S.C. § 119(a) to Patent Application No. 111212732 filed in Taiwan, R.O.C. on Nov. 21, 2022, the entire contents of which are hereby incorporated by reference.

### BACKGROUND

### Technical Field

The instant disclosure is related to a transportation machine applied in manufacturing industries, especially to a motion synchronized multi-tier pallet rack and battery formation apparatus having the same.

### Related Art

For an automation apparatus of a production line known to the inventor, especially for a transportation machine applied in lithium battery formation process, in most cases, a single line transportation is performed. In other words, in most case, a batch of products can be transported in a one-time operation; if multiple batches of products are to be transported, the products need to be transported through multiple separate operations.

### SUMMARY

Moreover, in a lithium battery formation process known to the inventor, lithium battery modules to be treated by the formation process (hereinafter, for the sake of convenience, referred to as lithium battery module) are initially carried to the vicinity of the formation cabinet through the conveyor. The lithium battery modules are taken from the conveyor by either a pallet rack or a robotic arm and then carried into the formation cabinet for the formation procedure. However, during a one-time operation, the pallet rack or the robotic arm known to the inventor can only perform the pick-and-place operation for the lithium battery modules in a single pallet, resulting in inefficient transportation performance of the pallet rack or the robotic arm. Consequently, the automation apparatus of the production line known to the inventor limits the overall production efficiency of products with a certain extent.

One of objects of one or some embodiments of the instant disclosure is to provide a motion synchronized multi-tier pallet rack and battery formation apparatus having the same. Therefore, according to one or some embodiments, a simplified mechanical design enables the simultaneous transportation for pallet in multi-tier configuration, thereby optimizing the accuracy and efficiency of product manufacturing, assembling, and transportation, and reducing time and labor costs.

To achieve the object, one or some embodiments provide a motion synchronized multi-tier pallet rack. The motion synchronized multi-tier pallet rack comprises a fixation rack, two movable frames, and two actuators. The two movable frames are respectively coupled to two corresponding sides of the fixation rack. The two actuators are respectively disposed on the two corresponding sides of the fixation rack and adapted to drive the two movable frames to move toward or away from each other. Each of the movable frames comprises a plurality of telescopic arms, a motor, and a drive rod. The telescopic arms are arranged into tiers and kinematically connected to the motor through the drive rod. For each of the movable frames, the motor is adapted to drive the telescopic arms to extend from or to retract into the movable frame.

In one or some embodiments, the fixation rack comprises a plurality of guiding rods extending along a first direction, each of the movable frames comprises a plurality of bushings, and each of the bushings is fitted over a corresponding one of the guiding rods. The two movable frames are guided by the guiding rods and the bushings to move toward or away from each other along the first direction. Each of the two actuators comprises a fixation mount and a movable head, the fixation mounts are respectively assembled on the two corresponding sides of the fixation rack, and the movable heads are respectively connected to the two movable frames. The actuator may be an electric cylinder, a pneumatic cylinder, or other equivalent device or mechanism that can perform linear movement.

In one or some embodiments, each of the movable frames further comprises a plurality of fixation plates and a plurality of gear assemblies. Each of the gear assemblies is assembled on a corresponding one of the fixation plates, and each of the telescopic arms is coupled to a corresponding one of the gear assemblies. For each of the movable frames, the gear assemblies are kinematically connected to a corresponding one of the drive rods, and each of the telescopic arms is driven by the corresponding one of the gear assemblies to extend from or retract into the movable frame along a second direction.

Each of the telescopic arms comprises a guiding mount and a movable arm, each of the movable arms comprises a gear rack, each of the guiding mounts is disposed on a corresponding one of the fixation plates, each of the movable arms is coupled to a corresponding one of the guiding mounts, and each of the gear racks is coupled to a corresponding one of the gear assemblies. Each of the movable arms is guided by the corresponding one of the guiding mounts to slide along the second direction.

In one or some embodiments, each of the movable arms comprises a first arm portion, a second arm portion, and a chain-pulley assembly. Each of the first arm portions is coupled to a corresponding one of the gear assemblies through a corresponding one of the gear racks. For each of the movable arms, the second arm portion is coupled to the first arm portion, and the chain-pulley assembly is coupled between the second arm portion and the first arm portion. The motion synchronized multi-tier pallet rack further comprises a plurality of position detectors, and the position detectors are disposed on the two corresponding sides of the fixation rack and arranged along one side of the movable arms in the second direction. Each of the movable arms further comprises two battery detecting devices respectively disposed on two corresponding sides of the second arm portion along the second direction.

To achieve the object, one or some embodiments provide a battery formation apparatus. The battery formation apparatus comprises at least one motion synchronized multi-tier pallet rack, at least one conveyor module, at least one formation cabinet, and a controller. The at least one conveyor module carries at least one battery module to be treated with a formation process. The controller is electrically connected to the at least one motion synchronized multi-tier pallet rack, the at least one conveyor module, and the at least on formation cabinet. The controller controls the at least one motion synchronized multi-tier pallet rack to obtain the at least one battery module from the at least one conveyor module and place the at least one battery module in the at least one formation cabinet.

In one or some embodiments, the at least one formation cabinet comprises a plurality of formation chambers. When the at least one motion synchronized multi-tier pallet rack carries a plurality of battery modules, the controller controls the at least one motion synchronized multi-tier pallet rack to place the battery modules in the formation chambers of the at least one formation cabinet simultaneously. Therefore, after the at least one motion synchronized multi-tier pallet rack places the battery modules in the formation cavities of the at least one formation cabinet simultaneously, the controller controls the two actuators to move the two movable frames away from each other and controls the telescopic arms to retract into the movable frames simultaneously.

As compared to the device known to the inventor, the pallet or apparatus according to one or some embodiments of the instant disclosure at least include following advantages: 1. the pallet rack or the apparatus has the function of simultaneous transportation and pick-and-place operation for multiple lines, apparently enhancing work efficiency for the transportation of production lines; 2. the pallet rack or the apparatus features a simpler and more reliable mechanical design, so that the pallet rack or the apparatus can be operated with minimized costs and occupied spaces; 3. the pallet rack or the apparatus incorporates an automated control function and a synchronized multi-mechanism operation design, so that the intelligent manufacturing can be achieved much easier.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of a motion synchronized multi-tier pallet rack according to an exemplary embodiment of the instant disclosure;

FIG. 2 illustrates a front view of the motion synchronized multi-tier pallet rack according to an exemplary embodiment of the instant disclosure;

FIG. 3 illustrates a perspective view of a fixation rack of the motion synchronized multi-tier pallet rack according to an exemplary embodiment of the instant disclosure;

FIG. 4 illustrates a side view of a movable frame of the motion synchronized multi-tier pallet rack according to an exemplary embodiment of the instant disclosure;

FIG. 5 illustrates a perspective view of a movable assembly on the movable frame of the motion synchronized multi-tier pallet rack according to an exemplary embodiment of the instant disclosure; and

FIG. 6 illustrates a schematic view of a system for a battery formation apparatus according to an exemplary embodiment of the instant disclosure.

### DETAILED DESCRIPTION

Prior to the description of a motion synchronized multi-tier pallet rack and battery formation apparatus having the same according to one or some embodiments is provided, it is understood that in the following descriptions, similar elements are denoted by identical reference numbers. Moreover, the figures in the instant disclosure are provided merely for illustrative purposes and may not necessarily be drawn to scale, and not all the details of the instant disclosure may be shown in the figures.

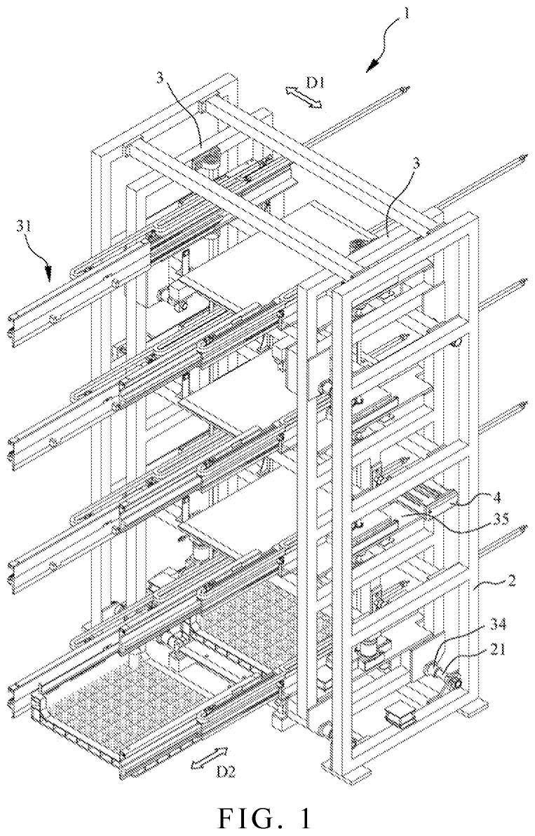

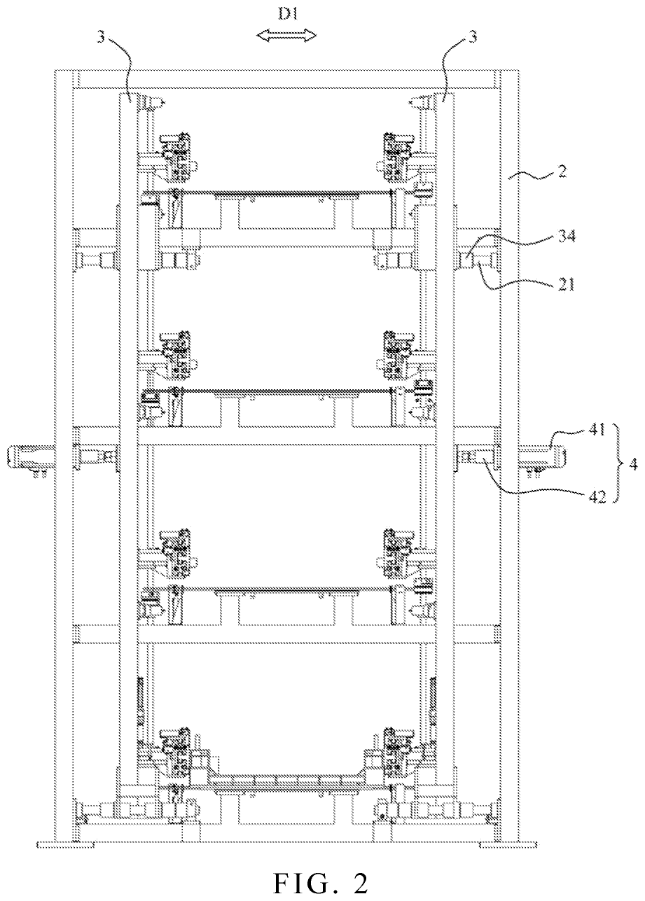

Please refer to FIG. 1 and FIG. 2. FIG. 1 illustrates a perspective view of a motion synchronized multi-tier pallet rack according to an exemplary embodiment of the instant disclosure, and FIG. 2 illustrates a front view of the motion synchronized multi-tier pallet rack according to an exemplary embodiment of the instant disclosure. As shown in the figures, in this embodiment, a motion synchronized multi-tier pallet rack 1 (hereinafter, for the sake of convenience, also referred to as rack) is provided, and the rack is a four-tier mechanism; however, the number of tiers of the rack can be flexibly adjusted corresponding to the number of tiers of a formation cabinet (not shown in FIG. 1 and FIG. 2). The motion synchronized multi-tier pallet rack 1 comprises a fixation rack 2, two movable frames 3, and two actuators 4.

The fixation frame 2 serves as a support structure for the main body of the motion synchronized multi-tier pallet rack 1, ensuring the stability and functionality of the rack, particularly in terms of transportation. The two movable frames 3 are movably disposed on two corresponding inner sides of the fixation rack 2 along a first direction D1. Likewise, the two actuators 4 are respectively disposed on two corresponding outer sides of the fixation rack 2, and the two actuators 4 are adapted to drive the two movable frames 3 to move toward or away from each other along the first direction D1.

Moreover, in some embodiments, each of the movable frames 3 comprises four telescopic arms 31, and the number of the telescopic arms 31 corresponds to the number of tiers of the motion synchronized multi-tier pallet rack 1 in a paired manner. The telescopic arms 31 are arranged on each of the tiers of the two movable frames 3 in a paired manner, and the telescopic arms 31 can extend from or retract into the movable frames 3. It should be noted that, for the sake of clarity to demonstrate the configuration of the telescopic arm 31 extending from the movable frame 3, in FIG. 1, pallet assemblies on the top three tiers of the motion synchronized multi-tier pallet rack 1 are omitted. In practical operation, the pallet assemblies are on all the four tiers of the motion synchronized multi-tier pallet rack 1.

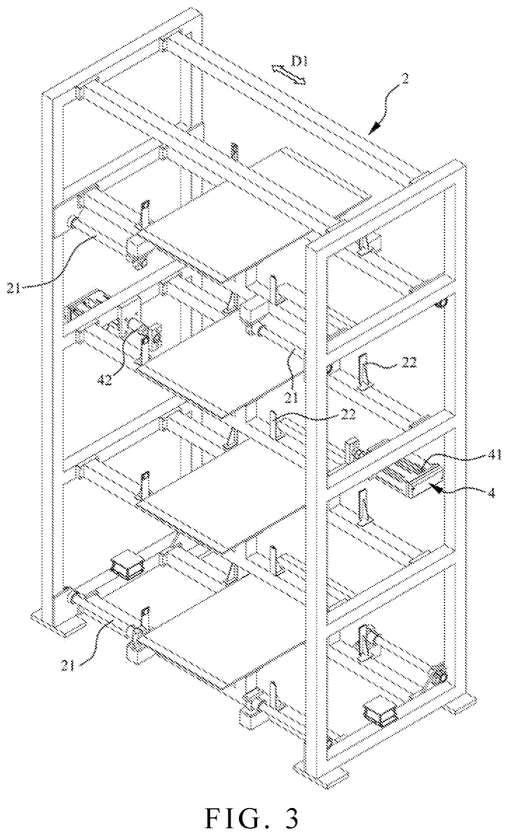

Moreover, please refer to FIG. 3. FIG. 3 illustrates a perspective view of a fixation rack of the motion synchronized multi-tier pallet rack according to an exemplary embodiment of the instant disclosure. The fixation rack 2 comprises eight guiding rods 21 arranged on the two corresponding inner sides of the fixation rack 2 in a paired manner. All the guiding rods 21 extend along the first direction D1. Each of the movable frames 3 comprises four bushings 34, and thus the motion synchronized multi-tier pallet rack 1 has eight bushings 34 arranged on two corresponding outer sides of the two movable frames 3. Each of the bushings 34 is fitted over a corresponding one of the guiding rods 21, so that the two movable frame 3 can be guided by the eight pairs of the guiding rods 21 and the bushings 34 fitted over the guiding rods 21 to move toward or away from each other along the first direction D1.

Furthermore, in this embodiment, each of the actuators 4 is an electric cylinder driven by a motor, and each of the actuators 4 comprises a fixation mount 41 and a movable head 42. The fixation mounts 41 are disposed on the two corresponding outer sides of the fixation rack 2. The movable heads 42 are located at the two corresponding inner sides of the fixation rack 2, and the movable heads 42 are respectively connected to the two corresponding outer sides of the two movable frames 3. The advantage of adopting the electric cylinder in this embodiment is that the range of the movement of the electric cylinder can be adjusted as needed so as to correspond to transported objects with different widths. However, it is understood that the actuator 4 is not limited to the electric cylinder; the actuator may be a pneumatic cylinder or other equivalent device or mechanism capable of performing linear motion.

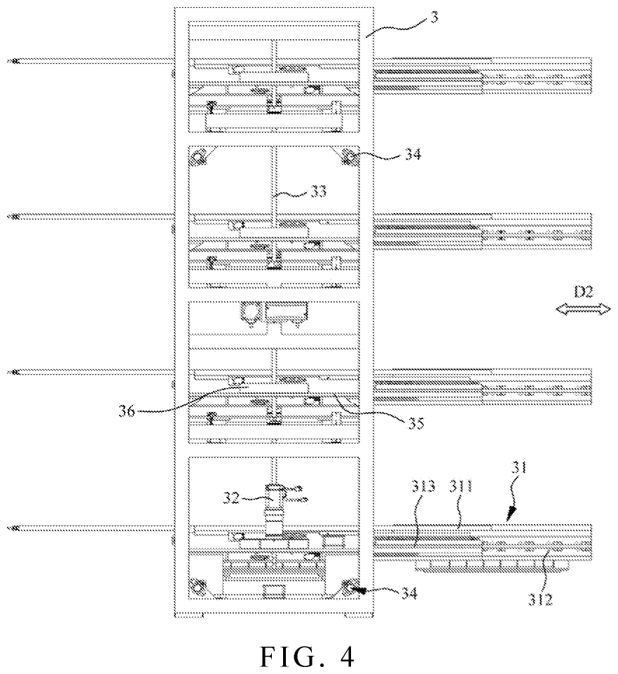

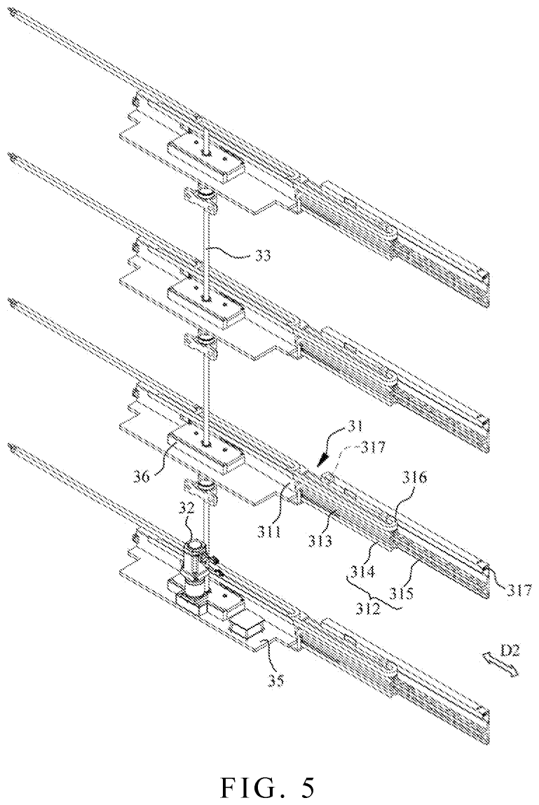

Please refer to FIG. 3, FIG. 4, and FIG. 5. FIG. 4 illustrates a side view of a movable frame of the motion synchronized multi-tier pallet rack according to an exemplary embodiment of the instant disclosure. FIG. 5 illustrates a perspective view of a movable assembly on the movable frame of the motion synchronized multi-tier pallet rack according to an exemplary embodiment of the instant disclosure. As shown, each of the movable frames 3, in addition to the four telescopic arms 31, further comprises a motor 32 and a drive rod 33. Therefore, the motion synchronized multi-tier pallet rack 1 comprises two motors 32 and two drive rods 33. Each of the four telescopic arms 31 is kinematically connected to a corresponding one of the motors 32 through the corresponding one of the drive rods 33. For each of the movable frames 3, the motor 32 is adapted to drive the telescopic arms 31 to extend from or to retract into the movable frame 3.

Moreover, in some embodiments, each of the movable frames 3 further comprises four fixation plates 35 and four gear assemblies 36. Therefore, the motion synchronized multi-tier pallet rack 1 comprises eight fixation plates 35 and eight gear assemblies 36. Each of the gear assemblies 36 is assembled on a corresponding one of the fixation plates 35, and each of the telescopic arms 31 is coupled to a corresponding one of the gear assemblies 36. The four gear assemblies 36 of each of the movable frames 3 is kinematically connected to a corresponding one of the drive rods 33, and each of the telescopic arms 31 is driven by the corresponding one of the gear assemblies 36 to extend from or retract into the movable frame 3 along a second direction D2.

Furthermore, in some embodiments, each of the telescopic arms 31 comprises a guiding mount 311 and a movable arm 312. Therefore, the motion synchronized multi-tier pallet rack 1 comprises eight guiding mounts 311 and eight movable arms 312. Each of the movable arms 312 comprises a gear rack 313. Therefore, the motion synchronized multi-tier pallet rack 1 comprises eight gear racks 313. Each of the guiding mounts 311 is disposed on a corresponding one of the fixation plates 35, each of the movable arms 312 is coupled to a corresponding one of the guiding mounts 311, each of the gear racks 313 is coupled to a corresponding one of the gear assemblies 36, and each of the movable arms 312 is guided by the corresponding one of the guiding mounts 311 to slide along the second direction D2.

Furthermore, in some embodiments, each of the movable arms 312 comprises a first arm portion 314, a second arm portion 315, and a chain-pulley assembly 316. Therefore, the motion synchronized multi-tier pallet rack 1 comprises eight first arm portions 314, eight second arm portions 315, and eight chain-pulley assemblies 316. Each of the first arm portions 314 is coupled to a corresponding one of the gear assemblies 36 through a corresponding one of the gear racks 313. For each of the movable arms 312, the second arm portion 315 is coupled to the first arm portion 314, and the chain-pulley assembly 316 is coupled between the second arm portion 315 and the first arm portion 314.

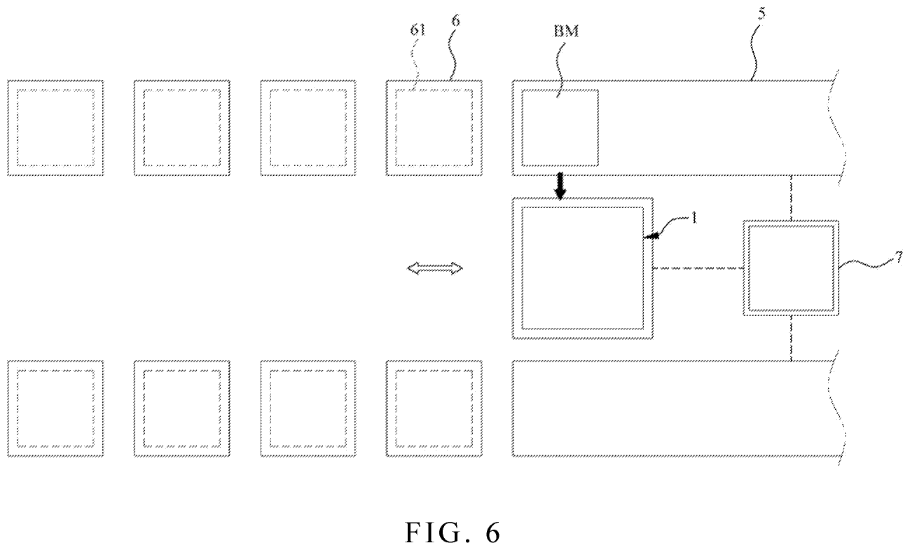

In this embodiment, each of the tiers of the motion synchronized multi-tier pallet rack 1 is additionally equipped with two position detectors 22. These position detectors 22 may employ an optical coupler configuration, typically comprising a light transmitter (often using infrared light) and a photoelectric receiver. In other words, in this embodiment, the position detectors 22 are disposed on the two corresponding inner sides of the fixation rack 2 and arranged along one side of the movable arms 312 in the second direction D2. In this embodiment, with the aid of the position detectors 22, the controller 7 (as shown in FIG. 6) can ascertain the movement status and position of the movable arms 312. For instance, the controller 7 can determine whether the movable arms 312 are in an extended position or a retracted position.

In some embodiments, each of the movable arms 312 further comprises two battery detecting devices 317. Therefore, the motion synchronized multi-tier pallet rack 1 comprises sixteen battery detecting devices 317. For each of the movable arms 312, the battery detecting devices 317 are disposed on two corresponding sides of the second arm portion 315 along the second direction D2. The battery detecting device may employ a photoelectric sensor configuration to determine the distance, absence, or presence of an object. Therefore, in this embodiment, with the aid of the battery detecting device 317, the controller 7 (as shown in FIG. 7) can ascertain whether the battery is held by two movable arms 312.

Then, please refer to FIG. 1 and FIG. 6. FIG. 6 illustrates a schematic view of a system for a battery formation apparatus according to an exemplary embodiment of the instant disclosure. As shown, in this embodiment, the battery formation apparatus comprises the motion synchronized multi-tier pallet rack 1 mentioned above, two conveyor modules 5, a plurality of formation cabinets 6 (eight formation cabinets 6 are illustrated in the figures), and a controller 7.

The controller 7 has a conventional structure and may include a processor, memory, storage media, communications devices, and input and output devices. For example, the controller 7 can be a standard microcontroller that includes a central processing unit (CPU), random access memory (RAM), read only memory (ROM) and input/output ports receiving input signals and sending output signals needed to control the system and to perform certain process steps as described herein. The functions described herein are generally programming instructions stored in memory and are performed by the logic of the CPU. Of course, the controller that performs the functions described herein could be a microprocessor using external memory or could comprise a combination of such a microprocessor or microcontroller combined with other integrated logic circuits. The controller 7 is generally incorporated into or works with a personal computer with a screen and input devices, such as keyboards, for inputting commands for process control and for monitoring the process control.

Moreover, in this embodiment, the conveyor module 5 is configured to carry battery modules to be treated with a formation process BM (hereinafter, for the sake of convenience, also referred to as battery module BM), the controller 7 is electrically connected to the motion synchronized multi-tier pallet rack 1, the conveyor modules 6, and the formation cabinets 6. The controller 7 is configured to control the motion synchronized multi-tier pallet rack 1 to retrieve the battery module BM from the conveyor module 5 and place the battery module BM within the formation cabinets 6, wherein each of the formation cabinets 6 comprises four formation chambers 61 arranged in tiers. Similarly, the conveyor modules 5 are organized into four tiers, with conveyors at each tier for transportation.

The operation of the apparatus is described as below. First, after the controller 7 controls the motion synchronized multi-tier pallet rack 1 to move to one side of the conveyor modules 5, the controller 7 controls the telescopic arms 31 of the motion synchronized multi-tier pallet rack 1 to extend from the movable frames 3 simultaneously to be at two corresponding sides of the battery module BM. Next, the controller 7 controls the two actuators 4 to move the two movable frames 3 toward each other so as to grasp the battery module BM, and the controller 7 controls the telescopic arms 31 to retract into the movable frames 3 simultaneously. During this process, the battery modules BM are loaded into the motion synchronized multi-tier pallet rack 1.

Then, the controller 7 controls the motion synchronized multi-tier pallet rack 1 to move to be in front of a corresponding one of the formation cabinets 6 and controls the two telescopic arms 31 held with the battery module BM (for the four tiers of the rack) to extend from the movable frames 3 in a synchronized manner and insert the battery module BM into the formation chambers 61. Next, the controller 7 controls the two actuators 4 to move the two movable frames 3 away from each other to place the battery module BM within the formation chamber 61. Consequently, the controller 7 controls the telescopic arms 31 to retract into the movable frames 3 simultaneously in preparation for subsequent transportations.

The above embodiments are merely examples for the purpose of illustration, and the scope claimed in the instant disclosure should be based on the claims, and is not limited to the above embodiments.

What is claimed is:

1. A motion synchronized multi-tier pallet rack, comprising:
a fixation rack;
two movable frames respectively coupled to two corresponding sides of the fixation rack;
two actuators respectively disposed on the two corresponding sides of the fixation rack and adapted to drive the two movable frames to move toward or away from each other;
wherein each of the movable frames comprises a plurality of telescopic arms, a motor, and a drive rod; the telescopic arms are arranged into tiers and kinematically connected to the motor through the drive rod; for each of the movable frames, the motor is adapted to drive the telescopic arms to extend from or to retract into the movable frame.

2. The motion synchronized multi-tier pallet rack according to claim 1, wherein the fixation rack comprises a plurality of guiding rods extending along a first direction, each of the movable frames comprises a plurality of bushings, and each of the bushings is fitted over a corresponding one of the guiding rods; the two movable frames are guided by the guiding rods and the bushings to move toward or away from each other along the first direction.

3. The motion synchronized multi-tier pallet rack according to claim 1, wherein each of the two actuators comprises a fixation mount and a movable head, the fixation mounts are respectively assembled on the two corresponding sides of the fixation rack, and the movable heads are respectively connected to the two movable frames.

4. The motion synchronized multi-tier pallet rack according to claim 2, wherein each of the movable frames further comprises a plurality of fixation plates and a plurality of gear assemblies; each of the gear assemblies is assembled on a corresponding one of the fixation plates, and each of the telescopic arms is coupled to a corresponding one of the gear assemblies; for each of the movable frames, the gear assemblies are kinematically connected to a corresponding one of the drive rods, and each of the telescopic arms is driven by the corresponding one of the gear assemblies to extend from or retract into the movable frame along a second direction.

5. The motion synchronized multi-tier pallet rack according to claim 4, wherein each of the telescopic arms comprises a guiding mount and a movable arm, each of the movable arms comprises a gear rack, each of the guiding mounts is disposed on a corresponding one of the fixation plates, each of the movable arms is coupled to a corresponding one of the guiding mounts, and each of the gear racks is coupled to a corresponding one of the gear assemblies; each of the movable arms is guided by the corresponding one of the guiding mounts to slide along the second direction.

6. The motion synchronized multi-tier pallet rack according to claim 5, wherein each of the movable arms comprises a first arm portion, a second arm portion, and a chain-pulley assembly; each of the first arm portions is coupled to a corresponding one of the gear assemblies through a corresponding one of the gear racks; for each of the movable arms, the second arm portion is coupled to the first arm portion, and the chain-pulley assembly is coupled between the second arm portion and the first arm portion.

7. The motion synchronized multi-tier pallet rack according to claim 6, further comprising a plurality of position detectors disposed on the two corresponding sides of the fixation rack and arranged along one side of the movable arms in the second direction; each of the movable arms further comprises two battery detecting devices respectively disposed on two corresponding sides of the second arm portion along the second direction.

8. A battery formation apparatus, comprising:
at least one motion synchronized multi-tier pallet rack comprising:
a fixation rack;
two movable frames respectively coupled to two corresponding sides of the fixation rack;
two actuators respectively disposed on the two corresponding sides of the fixation rack and adapted to drive the two movable frames to move toward or away from each other;
wherein each of the movable frames comprises a plurality of telescopic arms, a motor, and a drive rod; the telescopic arms are arranged into tiers and kinematically connected to the motor through the drive rod; for each of the movable frames, the motor is adapted to drive the telescopic arms to extend from or to retract into the movable frame;
at least one conveyor module carrying at least one battery module;
at least one formation cabinet; and
a controller electrically connected to the at least one motion synchronized multi-tier pallet rack, the at least one conveyor module, and the at least on formation cabinet;
wherein the controller controls the at least one motion synchronized multi-tier pallet rack to obtain the at least one battery module from the at least one conveyor module and place the at least one battery module in the at least one formation cabinet.

9. The battery formation apparatus according to claim 8, wherein the at least one formation cabinet comprises a plurality of formation chambers; when the at least one motion synchronized multi-tier pallet rack carries a plurality of battery modules, the controller controls the at least one motion synchronized multi-tier pallet rack to place the battery modules in the formation chambers of the at least one formation cabinet simultaneously.

10. The battery formation apparatus according to claim 9, wherein after the at least one motion synchronized multi-tier pallet rack places the battery modules in the formation cavities of the at least one formation cabinet simultaneously, the controller controls the two actuators to move the two movable frames away from each other and controls the telescopic arms to retract into the movable frames simultaneously.
